(19) United States
(12) Patent Application Publication
(10) Pub. No.: US 2010/0122824 A1
(43) Pub. Date: May 20, 2010

(54) Portable Fire Retardant Application Apparatus

(75) Inventor: James Aamodt, Hood River, OR (US)

Correspondence Address: HANCOCK HUGHEY LLP, P.O. BOX 1208, SISTERS, OR, 97759, US

(73) Assignee: Firebreak Spray Systems, Inc., Hood River, OR (US)

(21) Appl. No.: 12/270,973

(22) Filed: Nov. 14, 2008

(51) Int. Cl. A62C 31/28

(52) U.S. Cl. 169/16

(57) ABSTRACT

A self-contained fire retardant application apparatus include a tank for liquid fire retardant, a rechargeable 12 volt battery and an electrically operated pump powered by the battery. The tank has wheels or is carried on a wheeled chassis. In operation, the tank is wheeled to a desired location, the pump is powered and liquid fire retardant is sprayed onto the desired location through a hose and spray nozzle plumbed to the pump outlet.

### FIELD OF THE INVENTION

This invention relates to apparatus designed to apply fire retardant to specific sites, typically in an effort to protect structures from wildfire and/or to control wildfire behavior and direction, and more specifically, to a portable fire retardant application apparatus for distributing fire retardant in desired areas around and on the exterior surfaces of structures when needed, or in specific areas to impede wildfire progress.

### BACKGROUND

In recent years numerous wildfires, particularly in the Western regions of the United States, have destroyed thousands of homes and other structures. While these fires have been concentrated primarily in the Western states, the risk from wildfire to residences exists throughout the U.S. and in other parts of the world.

Over the past several decades there has been an increasing migration of population from cities and towns toward rural areas, and there has been a dramatic increase in the number of homes and communities being built at the interfaces between urban and forest lands—the so-called “urban-wildland” interface. As more homes and communities are built along the boundaries between urban and forested areas, and particularly in areas that are historically burned by wildfires, more and more of these structures are directly exposed to the risks of destruction by wildfires. This population and construction trend, coupled with historical timber management practices that have led to increased forest fuel loading in recent years, and drought conditions existing across the Western U.S. have led to an unprecedented number of structures being in danger of exposure to wildfires.

Conventional methods of fighting wildfires often have little impact when the fires enter the urban-wildland interface where residential subdivisions have been built, and wildfire fighters often can only stand back and watch as homes in the path of a wildfire are destroyed. The inability to prevent wildfire from destroying communities has been seen dramatically in the past several years, during which several highly publicized wild fires destroy thousands of homes in throughout the West, including Colorado, California, Nevada, Utah and other states.

The costs of fighting wildfires can be enormous. During the wildfire season of 2003, the costs of fighting wildfires in the Western portion of the U.S. have been estimated to be in the hundreds of millions of dollars.

But the costs associated with fighting wildfires pale in comparison to the costs of lost homes and other structures destroyed by wildfires. For example, according to the Insurance Services Office, Inc. (www.iso.com), the estimated insured losses arising out of the wildfires in San Diego and San Bernardino counties in Southern California in 2003 alone exceed over $2 billion. Of this, over $1 billion in payments arise out of a single wildfire—the Cedar Fire—which destroyed over 2,200 residential and commercial buildings. On a nationwide basis, the annual insured losses attributable to wildfires are undoubtedly much higher.

Given the staggering amounts of economic and environmental damage caused by wildfires, there is increasing interest in mitigation techniques that reduce the risks to both communities and forest lands. With respect to homes and communities, there are numerous wildfire mitigation strategies that can be taken to alleviate the risk of wildfires destroying residences. These include relatively simple measures such as establishing an effective “defensible space” around homes located in at-risk areas. Another simple approach that many communities have adopted on a community-wide basis is decreasing the fuel loads around urban-wildland interfaces. Good community planning before residential areas are built is also important, since it may be unwise to locate residential developments in areas that are highly prone to wildfires.

Nonetheless, homes, commercial structures and other buildings continue to be built at the edges of the urban areas where the risk of wildfire is the greatest, and even deep in forested areas. There are several known systems specifically designed to deliver fire retardant to and around structures when a wildfire threatens. As an example, Firebreak Spray Systems, LLC, the assignee of the present invention, manufactures and installs a variety of retardant application systems that are designed to be installed in and around homes. Another example of a large retardant application system is exemplified by U.S. Pat. No. 5,165,482, which describes a preemptive fire deterrent system that, among other things, applies water to specific areas on and around a structure when a wildfire approaches. Large systems such as those installed by Firebreak Spray Systems, LLC and that typified by the '482 patent are known to be effective, but for a variety of reasons, may not be appropriate for all homeowners and all situations. Specifically, there is a need for improved apparatus for applying fire retardant to specific locations, without all of the equipment and infrastructure needed in large systems.

The present invention defines a portable, self contained apparatus for applying fire retardant to specific locations, typically a structure or a perimeter around a structure in order to prevent flames from igniting the structure.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a first illustrated embodiment of a portable fire retardant application apparatus according to the present invention, showing the apparatus in perspective view.

FIG. 2 is an exploded perspective view of the apparatus illustrated in FIG. 1, showing certain components of the apparatus.

FIG. 3 is a bottom plan view of the apparatus shown in FIG. 1.

### DETAILED DESCRIPTION OF THE PREFERRED EMBODIMENTS

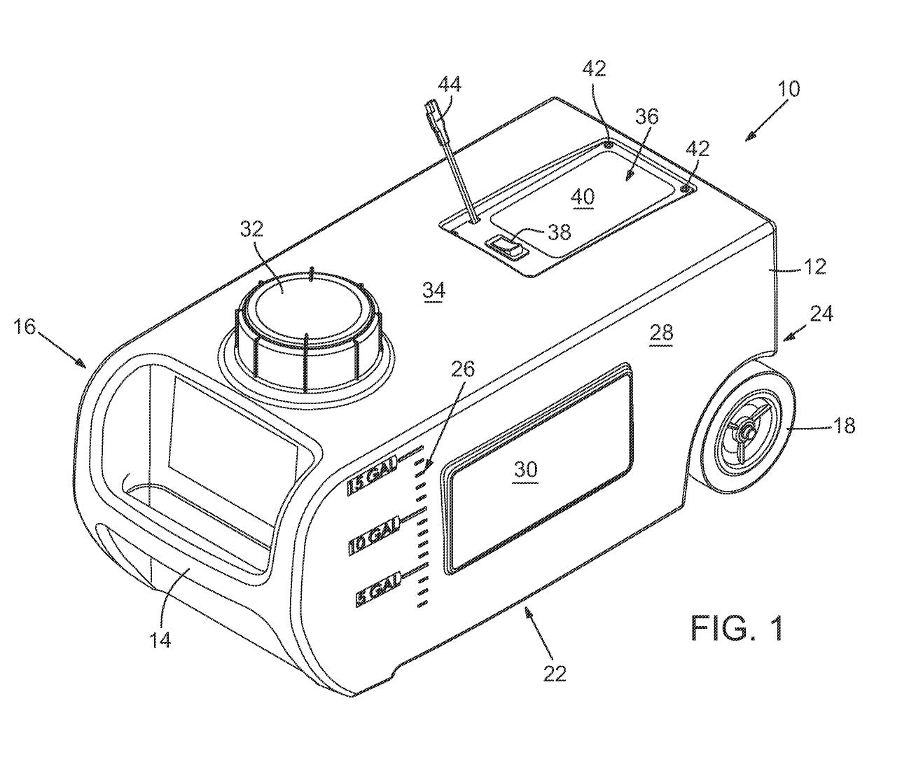

A first illustrated embodiment of a portable fire retardant application apparatus 10 according to the present invention is shown in FIGS. 1 through 3. At times in this detailed description of the invention structural features are described with reference to directional terms such as “upper”, “lower”, etc. Such relative directional terms correspond to the general naming convention based on the apparatus 10 as it rests on a ground plane with the wheels resting on the ground and with the handle end of the apparatus being the “forward” end. Continuing with examples based on this naming convention, the “rear” end of the apparatus is the end opposite the forward end, and so on, and the “interior” of the container refers to the interior of the fire retardant container, described below.

It should also be noted at the outset that the apparatus shown in the drawings and described herein is of a specific size. However, the invention is not limited to any specific size unless the invention defined in the claims is so-limited.

With reference now to FIG. 1, apparatus 10 comprises a main body that defines a container body or tank 12 for holding a liquid fire retardant agent. There are several liquid fire retardant's that are commercially available and which function well with the application apparatus 10 described herein. The fire retardant used in apparatus 10 is a liquid that flows readily through the plumbing systems and through the nozzles used with the apparatus. Because the retardant may not be used for several years after tank 12 is filled, the retardant is preferably not prone to degradation in effectiveness over time and stratification is preferably minimal. And because the fire retardant may be sprayed onto buildings, the retardant preferably does not discolor building surfaces, does not harm vegetation, and causes no environmental damage. Liquid fire retardant compositions available from Astaris (www.astaris.com) and sold under the brand name PHOS CHEK™ are one example of suitable fire retardants. Another suitable retardant is available under the brand name FIRE-TROL™ from various sources including www.firetrolcanada.com. Preferably the fire retardant that is used in system contains no colorants and/or is decolorized.

Tank 12 is preferably fabricated from a plastic material such as high density polyethylene that is lightweight, strong and chemically resistant to the fire retardant that is contained in the tank so that neither the tank nor the retardant degrades over time and storage. The tank 12 shown in the figures is formed in a single piece by injection molding. Tank 12 includes a handle 14 molded into the body at the forward end 16. A pair of wheels 18, only one of which is shown in FIG. 1, is attached to opposite ends of an axle 20 and the wheel/axle combination is attached to the lower side 22 of tank 12 at the rearward end 24 of the tank. It will be appreciated that the tank may equivalently be made portable by mounting the wheels to a separate chassis and mounting the tank to the chassis.

The tank 12 shown in FIG. 1 includes capacity graduation indicators 26 on side wall 28 of the tank. Preferably, the side wall of tank 28 is either translucent so that a user may readily see the fill-level of fire retardant contained in the tank, or a translucent fill window is provided so the user may inspect the volumetric amount of retardant in the tank 12. The tank 12 shown in the figures has a capacity of 15 gallons, but it will be appreciated that the volume of the tank may vary considerably and that the invention is not limited to any particular tank volume or size. A generally flattened label space 30 is formed as an integral part of tank 12 on side 28. Various indicia may be included on the label space, including blank space on which the user may write information such as the kind of fire retardant that is held in tank 12, and the date on which the retardant was added to the tank.

A cap 32 is threaded onto a fill opening on the upper surface 34 of tank 12. As detailed below, when cap 32 is removed the fill opening may be accessed to add retardant to the tank. Apparatus 10 includes a battery well or compartment 36 that contains a battery (described below) and a switch 38 which controls power to a pump, which also is described below. Battery compartment 36 defines a compartment that is sealed off from the interior of tank 12 and yet which defines a battery compartment that lies within the profile of the tank. A battery cover plate 40 that is removably attached to the tank with screws 42 that thread into threaded openings at cooperative positions in each of the four corners of the battery compartment to seal the battery into the compartment. A wiring harness 44 extends through cover plate 40 and provides an electrical connection to an external power source so that the battery may be charged.

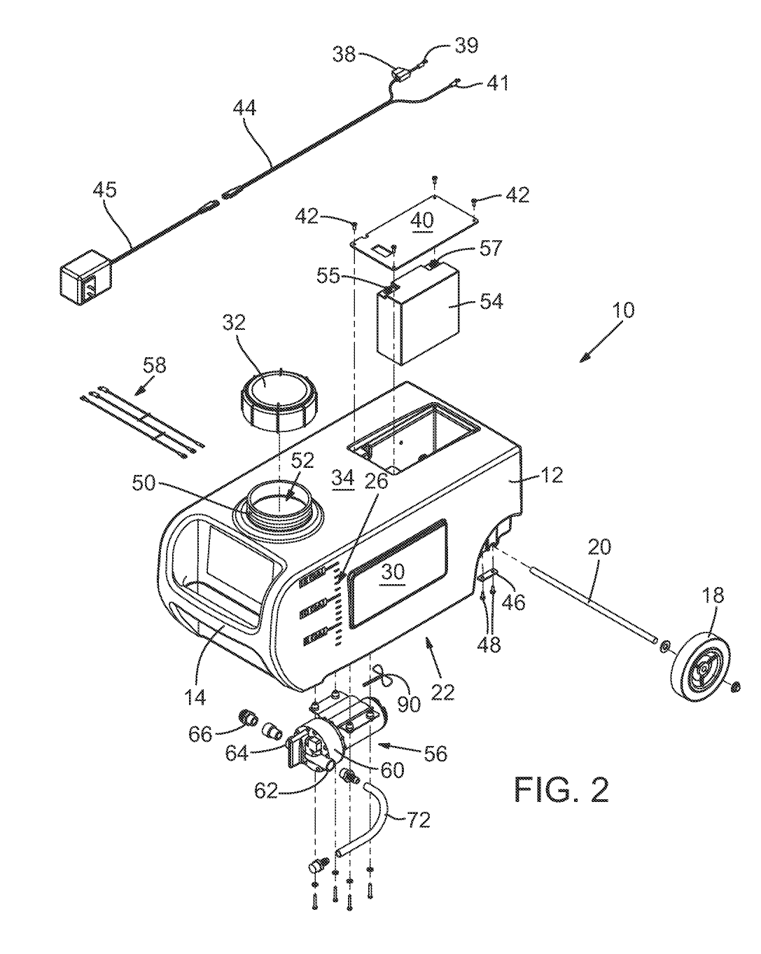

Turning now to FIG. 2, the components described above may be seen in an exploded view. Wheels 18 are attached to the opposite ends of axle 20 in any convenient manner and the axle is attached to the lower side 22 of tank 12 with keeper plates 46, which are attached to the tank with screws 48. Cap 32 is preferably internally threaded and threads onto an upwardly extending, threaded lip 50. When cap 32 is removed as shown in FIG. 2, an access opening 52 is defined into tank 12—fire retardant is added to tank 12 through access opening 52. As noted, battery compartment 36 defines a compartment that is sealed off from fire retardant that is contained in tank 12, yet as shown in FIG. 2, the compartment 36 is housed within the interior tank itself. The compartment 36 is preferably molded into the tank body or as an integral component thereof, or may be a separate component that is attached to the tank. In either case, the compartment 36 houses battery 54, which is a 12 volt battery that is electrically attached to and powers pump 56, which is attached to a recess formed in the lower surface 22 of tank 12.

The wiring harness that provides the electrical connection from the battery 54 to the terminals on pump 56 is shown generally with reference number 58. Preferably, the wiring connections extend through the interior of tank 12 directly from the battery to the pump. However, it will be appreciated that the electrical interconnections may be routed from the battery to the pump in any convenient manner. With battery 54 inserted into compartment 36 and the electrical interconnections made between the battery and the pump 56, the electrical connection between switch 38 and battery 54 is made and the cover plate 40 is screwed into place. In FIG. 2 the wiring harness 44 is illustrated removed from the battery 54 and a switch 38 is shown wired into the wiring that attaches to the positive terminal 55 of battery 54. Thus, end 39 of harness 44 attaches to positive terminal 55 and end 41 of the harness attaches to negative terminal 57.

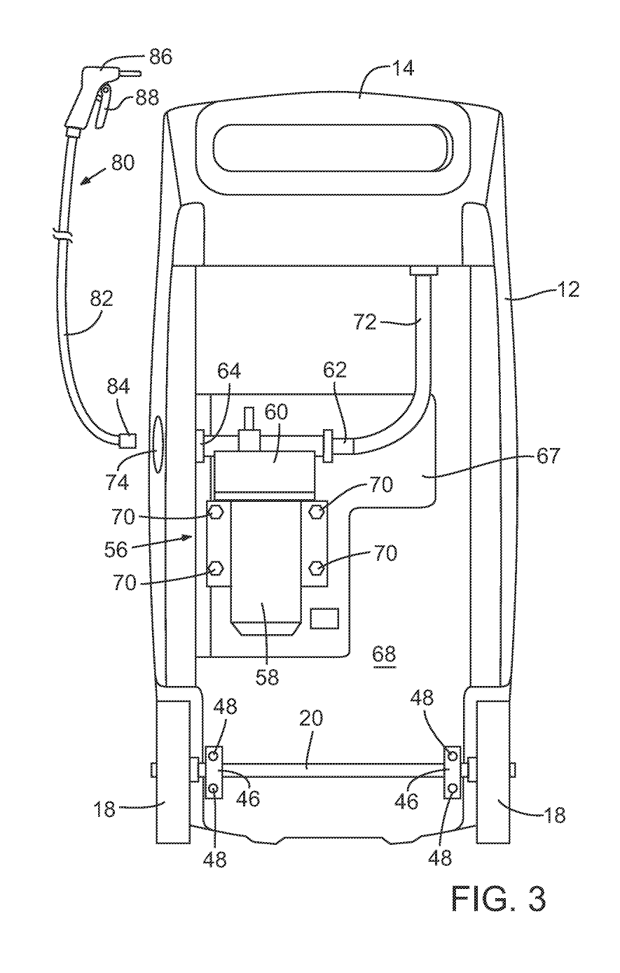

Pump 56 is a conventional pump that is has an electric motor 58 that is operable by 12 volt battery 54 and a pump unit 60 that has an inlet 62 that is fluidly connected to the interior of tank 12 and an outlet 64 that has a fitting 66 that may be connected to hosing and a nozzle assembly through which fire retardant is sprayed. More specifically, as shown in FIG. 3, pump 56 is bolted to a recess 67 that is formed in the lower surface 68 of tank 12 with four bolts 70. Pump inlet 62 is plumbed directly to tank 12 through tubing 72, which extends into the tank interior. Pump outlet 64 terminates at a fitting 66 which is housed in a recess 74 in the tank 12—the fitting is a coupler that is accessible from the side of the tank and is a standard detachable hose coupling. The combined pump inlet 62, pump 60 and pump outlet 64 defines a fluid flow path for fire retardant flowing from the interior of tank 12 to a hose and distribution nozzle assembly 80, which are shown schematically in FIG. 3 and which includes a hose 82 that has a hose coupler 84 on one end that is removably attachable to fitting 66, and a distribution nozzle such as spray nozzle 86 on the opposite end. Spray nozzle 86 preferably includes a manually operable trigger 88.

Some kinds of fire retardants that may be used in apparatus 10 may tend to stratify over time. Depending upon the type of fire retardant used, tank 12 may include an internal agitator such as a paddle-type mixer, powered by motor 58 and shown schematically in FIG. 2 with reference number 90 to keep the fire retardant homogenous over time. Alternately, the user may mix any fire retardant that has stratified by simply shaking the apparatus 10.

Operation of apparatus 10 will now be detailed. When apparatus 10 is not in use, or “idle”, the tank 12 may be stored either filled with liquid fire retardant or empty. Hose and nozzle assembly 80 may be either attached or detached. Preferably, battery 54 is connected to an external power source such as a standard 110 volt powered wall outlet with charger cord 45, which attaches to wiring harness 45 to charge the battery and maintain the battery in an optimally charged condition. When a homeowner or other user determines that a structure or other area is imminently threatened by wildfire or other fire threat, the owner detaches the charger cord 45 and makes sure that the hose and nozzle assembly 80 is connected. If the tank 12 is empty, the tank is filled with retardant. The entire apparatus 10 with tank 12 full is then wheeled to the location where retardant is to be applied and the switch 38 is moved to the “on” position. This begins operation of motor 58 and pump 56, and also mixing paddle 90 if the apparatus includes such a mixing device. Fire retardant is then sprayed through spray nozzle 86 onto whatever surfaces or structures the owner deems most appropriate. The fire retardant used in the apparatus 10 is preferably of the type that will remain on the surfaces onto which it has been sprayed, providing continuing protection against wildfire, until the retardant residual has been washed off.

As an alternative or option, pump 56 may be adapted for being powered by a secondary power supply such as 110 volt grid power supply. However, this requires an extension cord running from the power supply (i.e., either a powered wall outlet or a generator), and the range of the apparatus 10 is therefore limited.

The apparatus 10 according to the present invention defines a self-contained, fully powered and rechargeable retardant delivery system that may be stored until needed, then quickly wheeled to the location where retardant is to be applied. Even if grid power is interrupted by a wildfire, the apparatus 10 is fully powered and operable without an external power source.

While the present invention has been described in terms of a preferred embodiment, it will be appreciated by one of ordinary skill that the spirit and scope of the invention is not limited to those embodiments, but extends to the various modifications and equivalents as defined in the appended claims.

I claim:

1. Portable fire retardant application apparatus, comprising:
a tank having a tank interior and a fill opening into the tank;
a pump having a inlet fluidly connected to the tank interior and an outlet;
a power source electrically connected to the pump.

2. The portable fire retardant application apparatus according to claim 1 wherein the apparatus includes wheels.

3. The portable fire retardant application apparatus according to claim 2 wherein the power source is defined by a battery and wherein said battery is mounted to said tank.

4. The portable fire retardant application apparatus according to claim 3 wherein said battery is a 12 v rechargeable battery.

5. The portable fire retardant application apparatus according to claim 2 wherein said pump is mounted to said tank.

6. The portable fire retardant application apparatus according to claim 3 wherein said battery is housed in a battery compartment that is in the tank interior.

7. The portable fire retardant application apparatus according to claim 6 wherein the battery compartment is sealed relative to the tank interior.

9. Portable fire retardant application apparatus, comprising:
a wheeled tank having a tank interior configured for containing liquid fire retardant and an opening into the tank for filling the tank with liquid fire retardant;
a pump mounted to the tank, said pump having an inlet fluidly connected to the tank interior and an outlet configured for attachment to a hose and spray nozzle;
a battery mounted to the tank and electrically connected to the pump for operation of said pump to spray liquid fire retardant from said nozzle.

10. The portable fire retardant application apparatus according to claim 9 wherein the tank defines a periphery and the battery is mounted within the periphery.

11. The portable fire retardant application apparatus according to claim 10 wherein the battery is contained in a battery compartment that is within the tank interior.

13. The portable fire retardant application apparatus according to claim 11 wherein the battery compartment is fluidly sealed from the tank interior.

14. The portable fire retardant application apparatus according to claim 9 including mixing means for mixing liquid fire retardant contained in the tank.

15. The portable fire retardant application apparatus according to claim 14 wherein the mixing means comprises a paddle mixer.

16. Portable fire retardant application apparatus, comprising:
a wheeled tank having a tank interior configured for containing liquid fire retardant pump means mounted to the tank for pumping liquid fire retardant from said tank and delivering said liquid fire retardant to a fire retardant distribution means for distributing said liquid fire retardant on an object;
power supply means mounted to the tank for powering said pump means.

17. The portable fire retardant application apparatus according to claim 16 wherein the power supply means comprises a battery.

18. The portable fire retardant application apparatus according to claim 17 wherein the battery is mounted in a compartment within the tank interior.

19. The portable fire retardant application apparatus according to claim 18 wherein the compartment is sealed from the tank interior.

20. The portable fire retardant application apparatus according to claim 19 including secondary power supply means for powering said pump.
